(19) United States
(12) Patent Application Publication
(10) Pub. No.: US 2009/0173421 A1
(43) Pub. Date: Jul. 9, 2009

(54) Flatless Hybrid Isolated Tire

(75) Inventors: Mickey L. Love, Londonderry, NH (US); Robert S. Feldmann, Londonderry, NH (US); Christopher D. Stevens, Belmont, NH (US)

Correspondence Address: FREUDENBERG-NOK GENERAL PARTNERSHIP;LEGAL DEPARTMENT, 47690 EAST ANCHOR COURT, PLYMOUTH, MI, 48170-2455, US

(73) Assignee: FREUDENBERG-NOK GENERAL PARTNERSHIP, Plymouth, MI (US)

(21) Appl. No.: 11/970,809

(22) Filed: Jan. 8, 2008

(51) Int. Cl. B60B 9/02; B60C 7/00; B60B 15/04

(52) U.S. Cl. 152/246; 152/11

(57) ABSTRACT

A tire includes a rigid outer ring, a rigid inner ring, and an intermediate ring interconnecting the rigid outer ring and the rigid inner ring. The intermediate ring is biasingly compressible in a first direction and rigid in a second direction. The intermediate ring may include a plurality of lattice members and a resiliently compliant elastomer. The plurality of lattice members may be disposed within the resiliently compliant elastomer. The rigid outer ring and the rigid inner ring may include a solid cross-section.

### FIELD

The present disclosure relates to a tire and in particular to a flatless hybrid tire.

### BACKGROUND

The statements in this section merely provide background information related to the present disclosure and may not constitute prior art.

Many tires include a hollow rubber ring disposed around a metal or plastic inner rim. The hollow rubber tube is typically filled with air to provide elasticity. These air-filled tires are vulnerable to punctures or leaks, which allow air to escape from the hollow rubber ring, rendering the tire unsuitable for its intended purpose.

Other tires known in the art may include a continuous, solid cross-section formed from a single polymeric material. If formed from a relatively elastic polymer, these tires may lack the rigidity required for high performance applications. However, if these tires are formed from a relatively rigid polymer, these tires may transmit unacceptable levels of vibration to a bearing or axle, thus reducing the user ride comfort.

### SUMMARY

A tire includes a rigid outer ring, a rigid inner ring, and an intermediate ring interconnecting the rigid outer ring and the rigid inner ring. The intermediate ring is biasingly compressible in a first direction and rigid in a second direction. The intermediate ring may include a plurality of lattice members and a resiliently compliant elastomer. The plurality of lattice members may be disposed within the resiliently compliant elastomer. The rigid outer ring and the rigid inner ring may include a solid cross-section.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic side view of tires mounted to a roller ski according to the principles of the present disclosure;

FIG. 2 is a cross-sectional view of a tire according to the principles of the present disclosure;

FIG. 3 is a perspective view of a tire according to the principles of the present disclosure;

FIG. 4 is a side view of the tire shown in FIG. 3;

FIG. 5 is a perspective view of a tire according to an alternative embodiment of the present disclosure;

FIG. 6 is a cross-sectional view of a lattice member according to another alternative embodiment of the present disclosure;

FIG. 7 is a cross-sectional view of a lattice member according to yet another embodiment of the present disclosure;

FIG. 8 is a cross-sectional view of a lattice member according to still another embodiment of the present disclosure; and

FIG. 9 is a cross-sectional view of a lattice member according to still another embodiment of the present disclosure.

### DETAILED DESCRIPTION

The following description is merely exemplary in nature and is not intended to limit the present disclosure, application, or uses. It should be understood that throughout the drawings, corresponding reference numerals indicate like or corresponding parts and features.

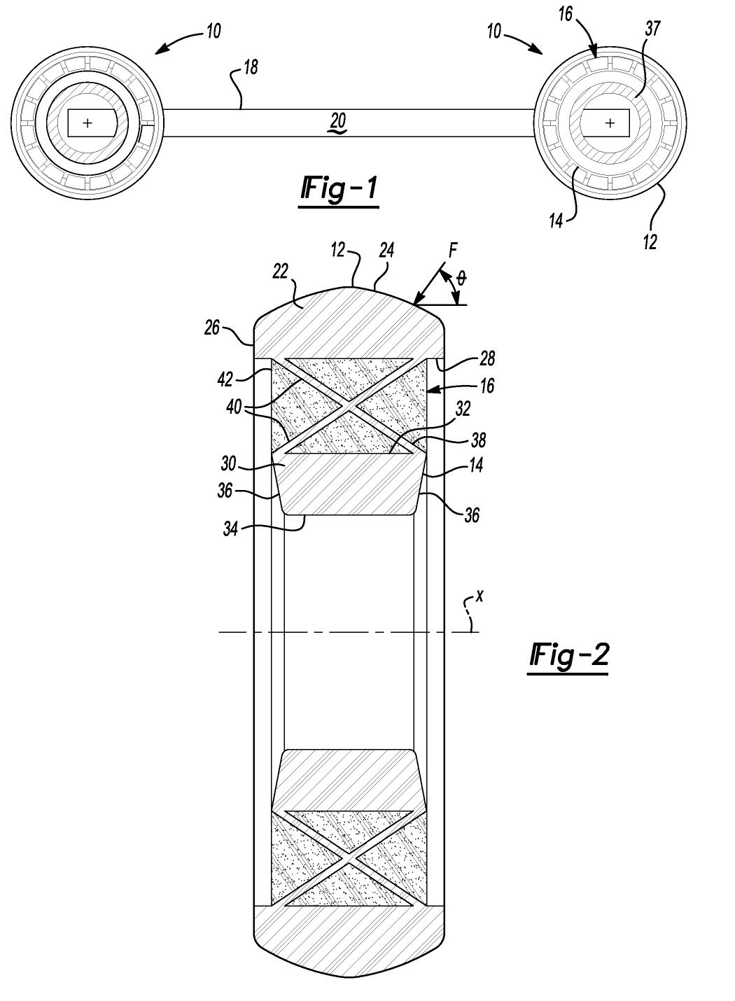

Referring to FIGS. 1-4, a flatless hybrid tire 10 is provided, and includes an outer ring 12, an inner ring 14, and an intermediate ring 16. The flatless hybrid tire 10 (or tire) may be rotatably mounted to a roller ski 18 (shown in FIG. 1) to facilitate rolling mobility therefor. The roller ski 18 may be a generally flat board 20, adapted to receive a plurality of wheels or tires, as is known in the art. It should be appreciated that the tire 10 may be rotatably mounted to any mobile apparatus including, but not limited to recreational and athletic equipment, such as in-line skates, scooters and roller skates, and transportation devices, such as carts for transporting sensitive instrumentation, lawn care vehicles, and other vehicles, for example.

The outer ring 12 may include a solid cross-section 22, with an arced outer diameter 24 (or other shape), sidewalls 26, and an inner diameter 28, as shown in FIG. 2. The outer ring 12 may be formed from a rigid elastomer, preferably polyurethane, natural rubber, or any other suitable elastomer adapted to provide low rolling resistance.

It should be appreciated that the outer ring 12 could include one or more thin elastomeric layers (not shown) laminated around the solid cross-section 22. The arced outer diameter 24 could include one or more tread features (known in the art; not shown) to further facilitate grip with a ground or road surface.

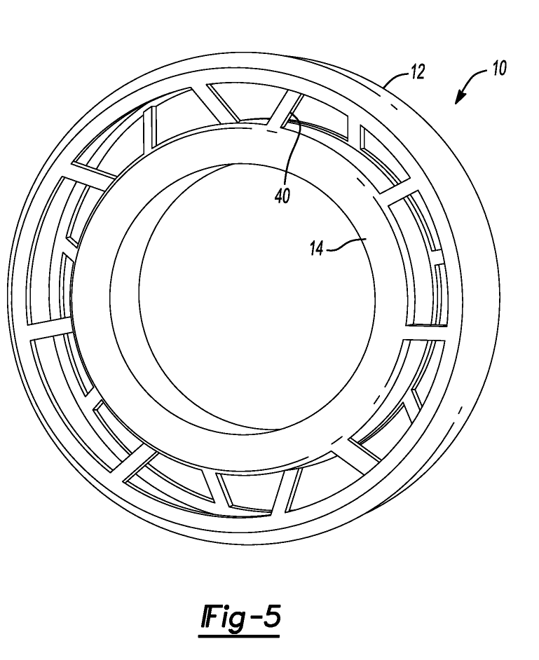

The inner ring 14 may be concentrically disposed within the inner diameter 28 of the outer ring 12, as shown in FIG. 4. Similar to the outer ring 12, the inner ring 14 may include a solid cross-section 30 formed from a rigid elastomer, preferably polyurethane or natural rubber. The inner ring 14 could include one or more thin elastomeric layers (not shown) laminated around the cross-section 30. The inner ring 14 may include an outer diameter 32, and inner diameter 34, and sidewalls 36.

The inner ring 14 may be adapted to receive a bearing assembly 37 (shown in FIG. 1) within the inner diameter 34 of the inner ring 14. The bearing assembly 37 may be engaged with the inner diameter 34 via press-fit, adhesive bond, or other suitable fastening means. Bearing assemblies are known in the art to enable the tire 10 to be mounted to the roller ski 18, for example, and facilitate rotation of the tire 10 about a rotational axis X. The bearing assembly 37 is preferably an Annular Bearing Engineers' Committee (ABEC) rated bearing, more preferably ABEC Class 4 or higher. It should be appreciated that the bearing assembly 37 could be any bearing assembly suitably operable to facilitate rotation of the tire 10 for a given application. Alternatively, the tire 10 can also be mounted to a wheel rim or other hub that is rotationally supported.

The intermediate ring 16 may be concentrically disposed between the outer ring 12 and the inner ring 14. The intermediate ring 16 is fixed to the inner diameter 28 of the outer ring 12 and the outer diameter 32 of the inner ring 14, thereby fixedly interconnecting the outer ring 12 and the inner ring 14. The intermediate ring 16 is a spring element operable to damp impact forces, and allow deflection of the outer ring 12 in a direction substantially perpendicular to the rotational axis X, while preventing deflection of the outer ring 12 in a thrust direction, as will be subsequently described.

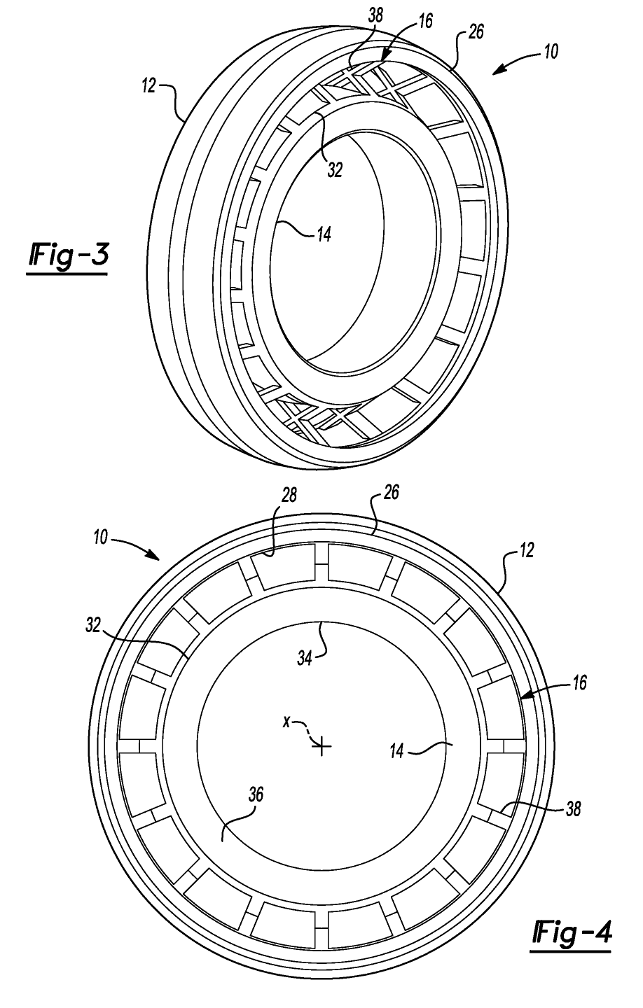

The intermediate ring 16 may include a plurality of lattice members 38. The lattice members 38 may extend radially between the inner diameter 28 of the outer ring 12 and the outer diameter 32 of the inner ring 14. The plurality of lattice members 38 may be formed from a rigid elastomer, preferably polyurethane or natural rubber. As shown in FIG. 2, the plurality of lattice members 38 may include a plurality of structural members 40, which may be diagonally disposed relative to each other. The structural members 40 may intersect each other to form a substantially X-shaped cross-section, as shown in FIGS. 2 and 3. As shown in FIG. 5, alternating structural members 40 may be diagonally disposed and opposing each other without intersecting. The lattice members 38 may be integrally molded with the outer ring 12 and the inner ring 14. Alternatively, the lattice members 38 may be mounted to the outer ring 12 and the inner ring 14 via conventional fasteners, adhesive bond, interference fit, or other known fastening techniques.

The intermediate ring 16 may also include a resiliently compressible isolation member 42. The isolation member 42 may be a resiliently compliant elastomer, such as micro-cellular urethane (MCU), or equivalents. The isolation member 42 may be disposed around and between the lattice members 38, as shown in FIG. 2. The isolation member 42 may be injected into the intermediate ring 16, or secondarily molded therein. It should be appreciated that alternative embodiments of the intermediate ring 16 may include only the isolation member 42, only the lattice members 38, or the lattice members 38 and the isolation member 42, as shown in FIG. 2.

With continued reference to FIGS. 1-4, the function of the tire 10 will be described. As described above, the tire 10 is operable to roll or rotate about the rotational axis X. During operation, the tire 10 is likely to be subjected to a variety of forces. For example, while rolling across a ground or floor surface, the tire 10 may encounter bumps and surface irregularities, which if rolled over, may transfer an impact force and/or vibration through the outer ring 12. A rider may apply a thrust force F to the tire 10 to provide thrust to facilitate locomotion of the roller ski 18. The thrust force F may be applied to the arced outer diameter 24 of the outer ring 12 at a thrust angle Θ. The thrust angle Θ is less than ninety degrees from the rotational axis X, and may be substantially as shown in FIG. 2. The thrust angle Θ between the direction of the thrust force F and the rotational axis X may be dependent upon the rider's preference. When skating or roller skiing, the thrust angle Θ may be defined by the angle of the rider's leg during thrust force application.

As shown in FIG. 2, the lattice members 38 extend outwardly toward the sidewalls 26, 36 in the general direction of the thrust force F. The lattice members 38 thus provide structural stiffness and rigidity in the direction of the thrust force F, preventing deflection of the outer ring in the direction of the thrust force F. However, the outwardly extending lattice members 38 allow the outer ring 12 to deflect inward in response to an impact force applied to the outer ring 12 at an angle substantially perpendicular to the rotational axis X.

The isolation member 42 disposed between the outer ring 12 and the inner ring 14 resiliently compresses to dampen impact forces and vibration transferred through the outer ring 1 2, reducing the transfer of energy from the impact forces and/or vibration to the inner ring 14 and thus to the roller ski 18, skate, or cart, for example.

It should be appreciated that an alternative embodiment of the intermediate ring 16 may include only one continuous lattice member 38 having the X-shaped cross-section, as described above, and extending continuously 360 degrees around the rotational axis X.

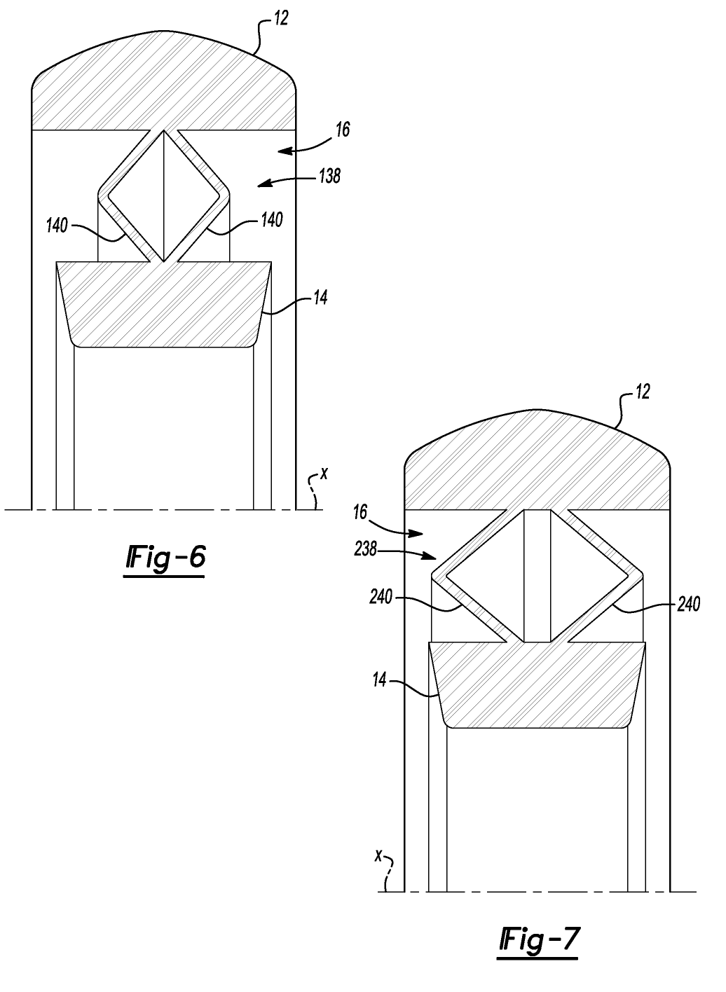

It should also be appreciated that the cross-sectional shape of the lattice members 38 are not limited to the X-shape shown in FIG. 2. With reference to FIGS. 6-9, additional alternative embodiments of the lattice members 38 are provided.

As shown in FIG. 6, the lattice members 138 may include a plurality of integrally formed chevron-shaped (V-shaped in the lateral direction) structural members 140. As shown in FIG. 7, the chevron-shaped structural members 240 may be spaced apart to form the lattice members 238.

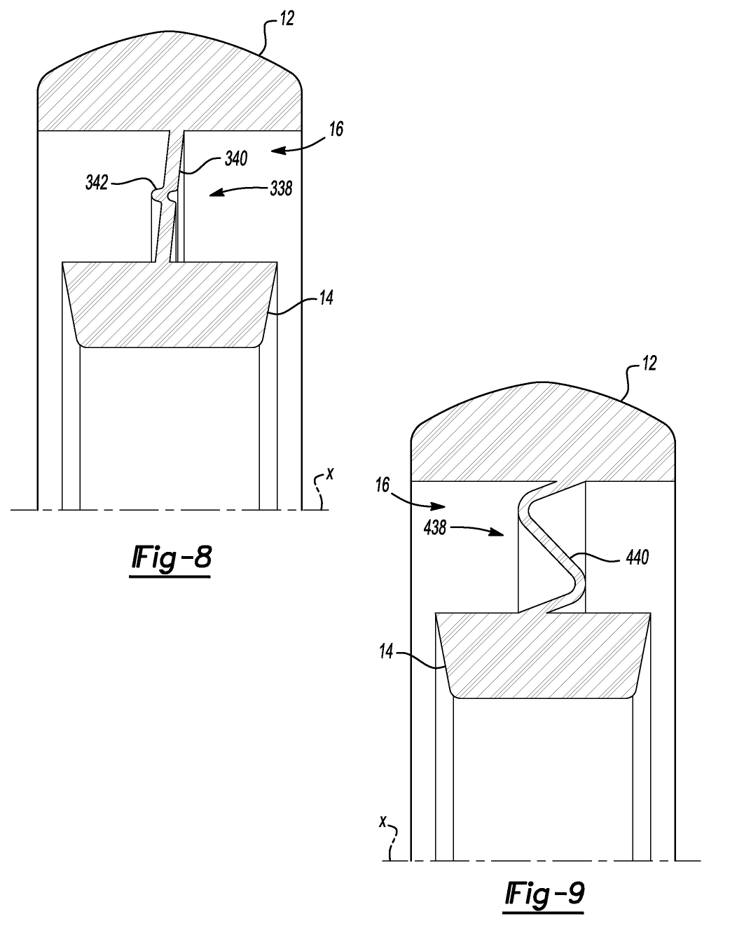

As shown in FIG. 8, each lattice member 338 may include a generally linear structural member 340 having a curved portion 342 to facilitate resilient deflection of the lattice members 338. Alternatively, as shown in FIG. 9, each lattice member 438 may include a splined structural member 440, which may include a substantially S-shaped cross-section. The lattice members 338, 438 may be disposed at an angle relative to the rotational axis X, or the lattice members 338, 438 may be disposed substantially perpendicular to the rotational axis X.

There are multiple advantages to the teachings of the present disclosure. First, the rigid elastomeric construction of the outer ring 12 facilitates low rolling resistance, while providing sufficient traction to prevent the tire 10 from slipping laterally during use. The relatively hard, rigid construction of the outer ring 12 also minimizes wear, increasing the functional life of the tire 10. As described above, the outer ring 12 may include a solid cross-section 22; thereby increasing the reliability of the tire 10 relative to air-filled tires known in the art, since, unlike the tire 10, a puncture may flatten an air-filled tire, rendering the air-filled tire unsuitable for its intended purpose.

As described above, the intermediate ring 16 provides a means for absorbing shock and vibration, which facilitates a smooth ride over uneven terrain. The isolation member 42 reduces stress to riders' joints by damping vibration and high impact loads. The elastic properties of the isolation member 42 may be tuned for a particular rider, based on the rider's mass or the rider's expected performance requirements. For example, a rider with higher mass may desire the isolation member 42 to be formed from a stiffer elastomer to optimize damping and deflection properties. Similarly, a more aggressive rider utilizing the tire 10 for a high performance, competitive athletic application, for example, may desire the isolation member 42 to be formed from a stiffer elastomer relative to the softer isolation member 42 which may be more suitable for a recreational rider.

The stiffness and angle of the lattice members 38, 138, 238, 338, 438 relative to the sidewalls 26, 36 may also be tuned according to the preferences and mass of a given rider. The orientation of the lattice members 38,138, 238, 338, 438 may be optimized according to the rider's expected thrust angle Θ; i.e., the structural members 40, 140, 240, 340, 440 may be oriented substantially inline with the rider's expected thrust angle Θ to prevent deflection in the direction of the thrust angle Θ. This will allow a rider to realize greater thrust propulsion.

The description of the present disclosure is merely exemplary in nature and, thus, variations that do not depart from the gist of the disclosure are intended to be within the scope of the disclosure. Such variations are not to be regarded as a departure from the spirit and scope of the disclosure.

What is claimed is:

1. A tire comprising:
an outer ring;
an inner ring concentric with said outer ring; and
a spring element disposed between said outer ring and said inner ring, said spring element including at least one lattice member.

2. The tire according to claim 1, wherein said spring element allows said outer ring to deflect in response to a force applied to said outer ring in a first direction.

3. The tire according to claim 1, wherein said spring element prevents deflection of said outer ring in response to a force applied to said outer ring in a second direction.

4. The tire according to claim 1, wherein said at least one lattice member includes a plurality of structural members.

5. The tire according to claim 4, wherein said plurality of structural members are angled toward a sidewall of said outer ring.

6. The tire according to claim 1, wherein said spring element includes a resiliently compressible isolation member.

7. The tire according to claim 6, wherein said resiliently compressible isolation member is operable to damp vibration.

8. The tire according to claim 1, wherein said outer ring has a solid cross-section.

9. The tire according to claim 1, wherein said outer ring includes an arced outer diameter surface.

10. The tire according to claim 1, wherein said outer ring is formed from an elastomer.

11. A tire comprising:
a rigid outer ring;
a rigid inner ring; and
an intermediate ring interconnecting said rigid outer ring and said rigid inner ring,
wherein said intermediate ring is biasingly compressible in a first direction and rigid in a second direction.

12. The tire according to claim 11, wherein said rigid outer ring includes a solid cross-section.

13. The tire according to claim 11, wherein said intermediate ring includes a resiliently compressible isolation member.

14. The tire according to claim 13, wherein said resiliently compressible isolation member is operable to prevent vibration transfer between said rigid outer ring and said rigid inner ring.

15. The tire according to claim 11, wherein said intermediate ring includes a plurality of lattice members.

16. The tire according to claim 15, wherein said plurality of lattice members are disposed within a resiliently compressible isolation member.

17. The tire according to claim 15, wherein said plurality of lattice members include a substantially X-shaped cross-section.

18. The tire according to claim 15, wherein said plurality of lattice members include a substantially chevron-shaped cross-section.

19. The tire according to claim 15, wherein said plurality of lattice members include a curved cross-section.

20. The tire according to claim 11, wherein said rigid outer ring includes an arced outer surface.

21. A tire comprising:
a solid outer ring;
a solid inner ring; and
a resilient intermediate ring disposed between said solid outer ring and said solid inner ring, said resilient intermediate ring including a plurality of lattice members, said plurality of lattice members extending in a direction substantially toward a sidewall and interconnecting said solid outer ring and said solid inner ring.

22. The tire according to claim 21, wherein said plurality of lattice members facilitate deflection of said solid outer ring in a direction substantially perpendicular to a rotational axis.

23. The tire according to claim 21, wherein said plurality of lattice members prevent deflection of said solid outer ring in response to a force applied at a thrust angle.

24. A tire comprising:
an outer ring;
an inner ring;
at least one lattice member extending radially between said outer ring and said inner ring, said at least one lattice member interconnecting said outer ring and said inner ring, said at least one lattice member allowing said outer ring to deflect in a first direction and prevents deflection of said outer ring in a second direction; and
a resiliently compliant elastomer disposed around said at least one lattice member.
